(19) United States
(12) Patent Application Publication
(10) Pub. No.: US 2002/0052753 A1
(43) Pub. Date: May 2, 2002

(54) Print order acceptance system and method

(75) Inventor: Yasuhiro Shinkai, Saitama (JP)

Correspondence Address: SUGHRUE, MION, ZINN, MACPEAK & SEAS, PLLC, 2100 Pennsylvania Avenue, N.W., Washington, DC, 20037, US

(73) Assignee: FUJI PHOTO FILM CO., LTD

(21) Appl. No.: 09/863,476

(22) Filed: May 24, 2001

(30) Foreign Application Priority Data
May 30, 2000 (JP) P.2000-160738

(51) Int. Cl. G06F 17/60; B41B 1/00; B41J 1/00; G06K 1/00; B41F 1/00; G06F 15/00

(52) U.S. Cl. 705/1; 358/1.15

(57) ABSTRACT

An order accept machine 1 accepts digital image data and order information and transfers the thus-accepted digital image and order information to an image printer 3. The order acceptance machine 1 is disposed at, for example, a shop. The image printer 3 is a printer capable of printing high-quality photo-prints from digital image data at high speed. The image printer 3 is to be installed in a large-scale DPE shop (a shop offering both development and reprint services) or a laboratory. A voucher printer 2 prints a voucher representing details of a print order. The voucher printer 2 has the function of printing details of an order and ordered thumbnail images.

### BACKGROUND OF THE INVENTION

1. Field of the Invention

The present invention relates to a print order acceptance system and a print order acceptance method, wherein an order for printing images on the basis of digital image data is received by an order acceptance machine disposed at a shop.

2. Description of the Related Art

Digital image data can be readily preserved, managed, processed, and printed by means of a personal computer. Hence, demand for digitization of a silver film has increased, and digitization service is now becoming prevalent.

A hardcopy produced from digital image data can be readily produced by means of a printer connected to a personal computer. However, the hardcopy is of far lower quality and cost than is a photo-print produced by a custom-designed photo-printer. Hence, photo-prints still remain in great demand. In response to such demand, there is now becoming pervasive a service in which digital image data are entered through use of an order acceptance machine disposed at a shop and a printout is produced by a printer. A printer used for printing high-precision photographs is expensive and involves low processing speed. For these reasons, there is employed a general method, in which orders from a plurality of customers are accepted collectively, and photographs are printed in a single operation.

A Service of collectively accepting orders has been implemented as related-art service for producing reprints of a negative film. The number of reprints is written on a film bag. If necessary, the customer can ascertain the reprints upon acceptance.

However, in an image order system using digital image data, the customer usually cannot ascertain images to be printed and details of an order, because they images are in the form of electronic data. Even at the time of receipt of prints, the user cannot ascertain a match between ordered images and print images. In some cases, a problem arises between the customer and a sales clerk.

### SUMAMRY OF THE INVENTION

The present invention provides an order system and method which enable a customer to ascertain details of an order for producing prints from digital image anytime after the customer has placed the order.

The present invention enables a person who has placed an order to ascertain ordered thumbnail images. According to inventions defined in claims 1 through 5 and claim 10, in order to enable ascertainment of thumbnail images, thumbnail images are printed on a voucher which doubles are a claim ticket to be used for accepting prints. According to inventions defined in claims 6 through 9 and claim 11, thumbnail images are transmitted by means of electronic mail to the person who has placed the order. As a result, the person can ascertain details of the order by means of a portable cellular phone, as required.

### BRIEF DESCRIPTION OF THE DRAWINGS

FIG. 1 is a block diagram showing the schematic configuration of a print order acceptance system according to a first embodiment of the present invention;

FIG. 2 shows a flow of operations required for placing an order of prints according to the first embodiment;

FIG. 3 is an example display appealing when selection of images to be ordered and entry of details of an order are performed;

FIG. 4 shows an example voucher to be printed;

FIG. 5 is a block diagram showing the schematic configuration of a print order acceptance system according to a second embodiment of the present invention;

FIG. 6 shows a flow of operations required for placing an order of prints according to the second embodiment; and

FIG. 7 shows display examples appearing when thumbnail images and order information are ascertained by use of a portable cellular phone.

### DESCRIPTION OF THE PREFERRED EMBODIMENTS

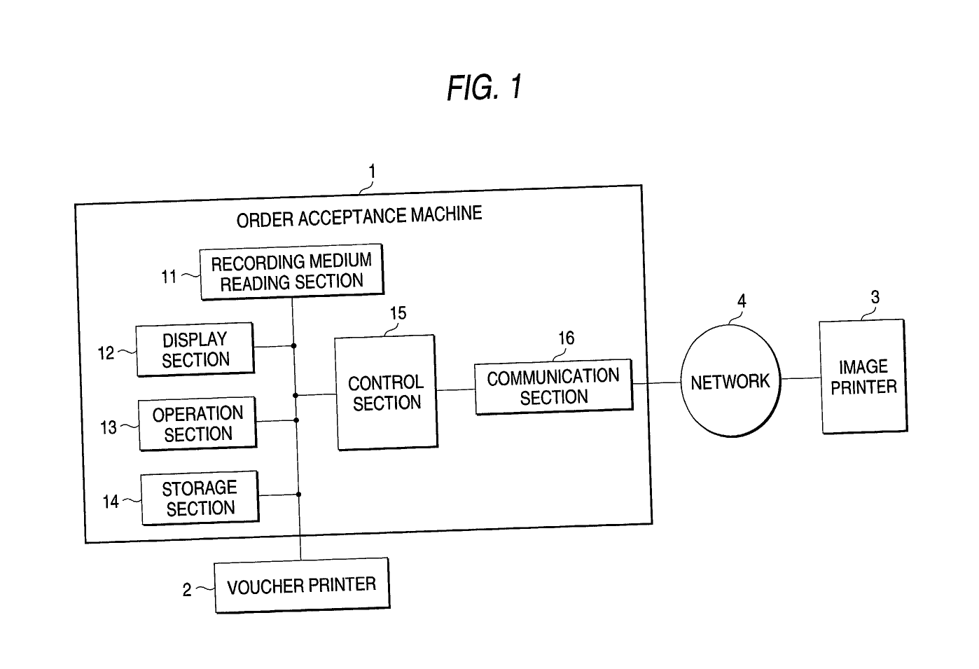

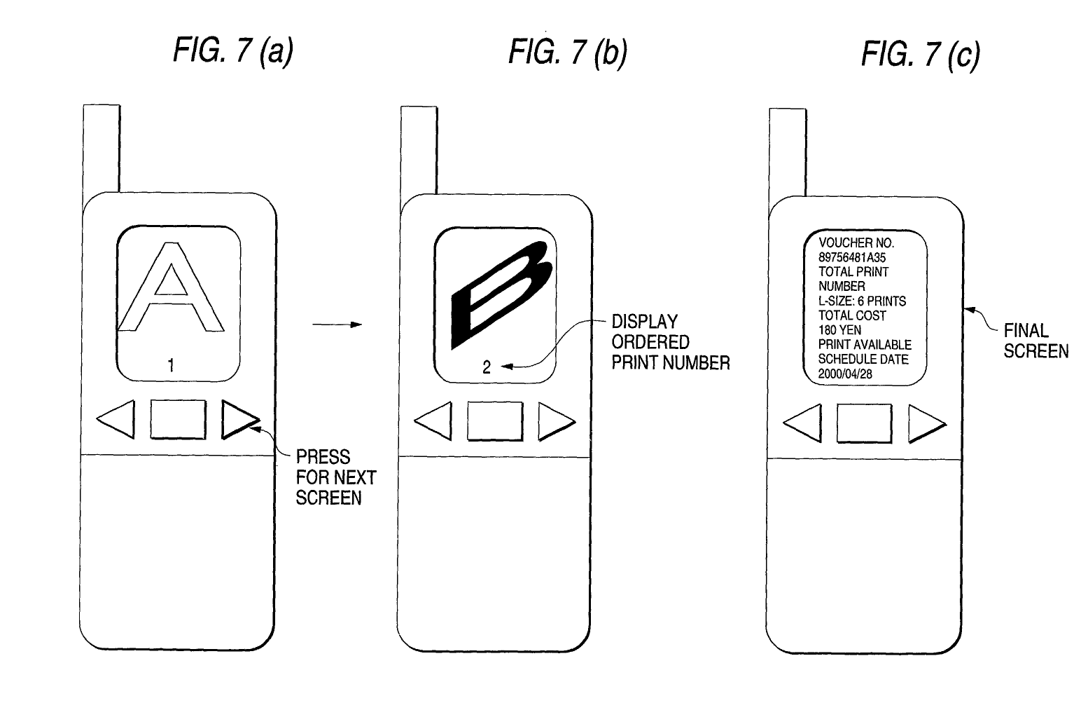

Embodiments of the present invention will be described hereinbelow by reference to FIGS. 1 through 7.

(First Embodiment)

FIG. 1 is a block diagram showing the schematic configuration of an order acceptance system according to a first embodiment of the present invention. An order acceptance machine 1 accepts digital image data and order information and transfers the thus-accepted digital image and order information to an image printer 3. The order acceptance machine 1 is disposed at, for example, a shop. The image printer 3 is a printer capable of producing high-quality photo-prints from digital image data at high speed. The image printer 3 is to be installed in a large-scale DPE shop or a laboratory. A network 4 effects transfer of data between the order acceptance machine 1 and the image printer 3. The order acceptance machine 1 and the image printer 3 are usually disposed apart from each other. Hence, they are preferably interconnected by way of the network 4. However, the present invention is not limited to such a construction; an order acceptance machine to be disposed at a large-scale DPE shop may be connected directly to the image printer 3. A voucher printer 2 prints a voucher representing details of a print order. The voucher printer 2 has the function of printing details of an order and ordered thumbnail images. Since the voucher printer 2 is not intended for producing a large number of prints, the voucher printer 2 does not have to be a high-performance printer.

The order acceptance machine 1 comprises a recording medium recording section 11, a display section 12, an operation section 13, a storage section 14, a control section 15, and a communications section 16. The recording medium reading section 11 reads image data stored in any of various types of recording mediums. The thus-read image data are stored in the storage section 14. The display section 12 displays operation procedures of the order acceptance machine 1 or images corresponding to digital image data. The operation section 13 enables a person (who places an order and will be called hereinafter simply a “customer”) to enter instructions or data through use of the order acceptance machine 1. The operation section 13 is made up of a touch panel and keys. The storage section 14 is used for storing read images or programs and is used as a work area when the order acceptance machine 1 is operative. The control section 15 controls the overall operation of the order acceptance machine 1. More specifically, the control section 15 is primarily made up of a processor which operates in accordance with a program stored in the storage section 14. The communications section 16 controls exchange of data by way of the network 4.

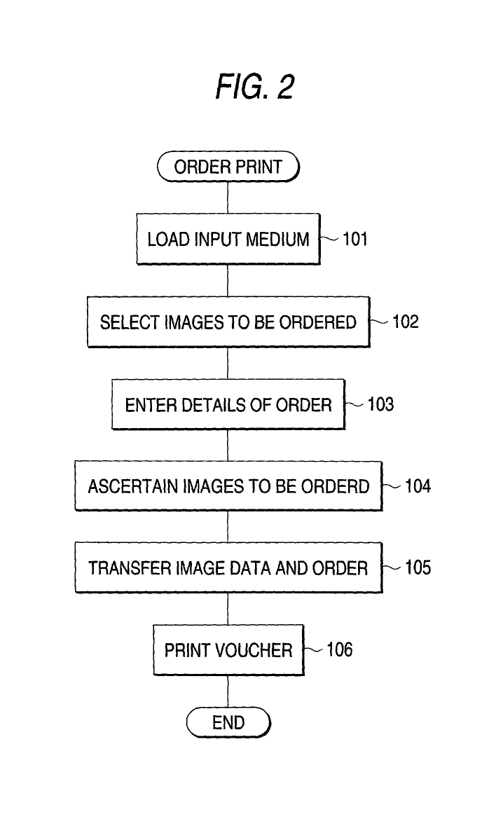

FIG. 2 shows flow of operations required when an order for prints is placed by utilization of the order acceptance system shown in FIG. 1. When an order for prints is placed, a recording medium on which are recorded digital images to be ordered is selected (step S101). The selectable recording medium corresponds to any of various types of recording mediums to be used with a digital camera, or a CD-R, an FD, or a DVD used in a service for digitizing a silver film photograph.

A recording medium prepared by a customer is loaded into a corresponding slot provided in the recording medium reading section 11, where images to be printed are selected (step 102). Selection of an image can be effected, by means of displaying images pertaining to image data recorded on the recording medium, and selecting one from the images by way of the operation section 13 such as a touch panel. Next, details of the order; that is, a print size and the number of prints, are entered in connection with the thus-selected image (step 103).

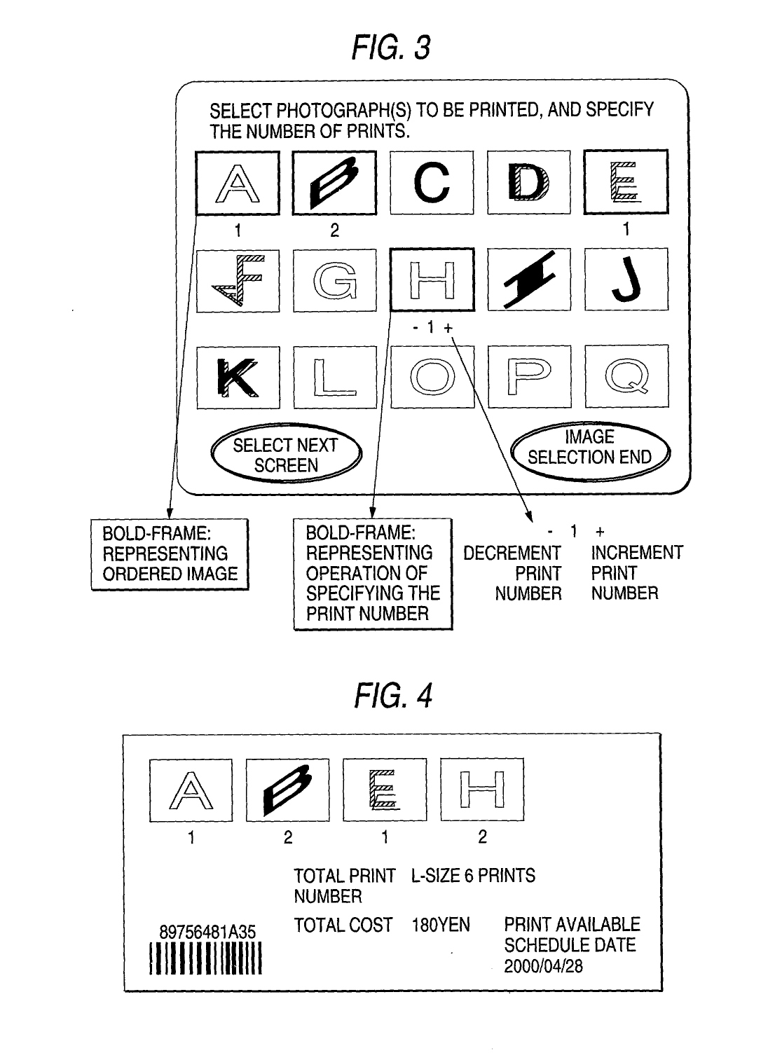

FIG. 3 shows an example of a display appearing on the display section 12 when selection of an image to be ordered or entry of details of an order is effected. On a touch panel, the surface of an image to be selected is touched while a plurality of images read from the recording medium are displayed on the display section 12, as a result of which an image is selected. The thus-selected image is distinguished, by means of changing the brightness or hue of the image (for the sake of convenience of explanation, assume that the image is displayed with a thick frame). When an image is selected, “−1+” appears in a position below the selected image. By means of touching the surface of icon “−” or “+,” the number of prints of the thus-selected image can be incremented or decremented. If images to be displayed other than the displayed images still remain, “SELECT NEXT SCREEN” is to be touched, thereby displaying other images. Operations analogous to those mentioned above are performed. When selection of images has been completed, “IMAGE SELECTION END” is to be touched, whereby selection of images to be ordered is completed.

Selection of images and entry of details of the order have been completed, the images and the details of the order are ascertained (step 104). Ascertainment is effected by means of displaying images such as those shown in FIG. 4 and prompting the customer to perform ascertainment operation.

After completion of ascertainment of the images and the order, the details of the order are transferred (step 105), and a voucher is printed (step 106). In the example shown in FIG. 2, transfer of the images and the order is followed by printing operation. The sequence in which transfer of the image data and details of the order and printing of a voucher are to be performed may be changed. Transfer of image data and details of the order is performed by way of the communications section 15 and the network. A voucher is printed, by means of sending to the voucher printer 2 thumbnail image data pertaining to the ordered images and data representing the details of the order. Then, the voucher printer 2 produces printouts. Example vouchers to be printed are shown in FIG. 4.

Image data read from a recording medium brought by the customer or image data prepared by the order acceptance machine 1 are used as thumbnail image data to be used for printing. More specifically, there may be a case where low-resolution thumbnail data as well as high-precision image data are recorded on a CD-R, an FD, or a DVD prepared by a service of digitizing silver film photographs. In the case of such a recording medium, image data read from the recording medium are used as thumbnail image data. In the case of a medium for use with a digital camera or a recording medium having no image data recorded thereon, thumbnail image data are prepared on the basis of high-precision image data.

When a voucher is printed, the customer can ascertain the ordered images and details of the order. In the case of a prepayment system, a printed voucher is brought to a checkout station of the shop where the order acceptance machine 1 is disposed, and charges described on the voucher are to be paid. In the case of a prepayment system, oversight of collection of charges can be avoided, so long as the voucher printer 2 is disposed in the vicinity of the checkout station. Alternatively, an automatic payment machine is disposed in the vicinity of the order acceptance machine 1. A voucher may be printed after charges have been paid. In the embodiment shown in FIG. 1, the voucher printer 2 and the order acceptance machine 1 are disposed separately from each other. However, if the voucher printer 2 is not disposed in the vicinity of a checkout station, the order acceptance machine 1 and the voucher printer 2 may be assembled into a single unit.

The voucher received by the customer is used for checking when the customer receives the ordered photo-prints. Since the thumbnail images are printed on the voucher, the voucher is provided to the customer. If a peel-off sticker is used as paper for printing a voucher, usefulness of the voucher to the customer is enhanced to a much greater extent.

(Second Embodiment)

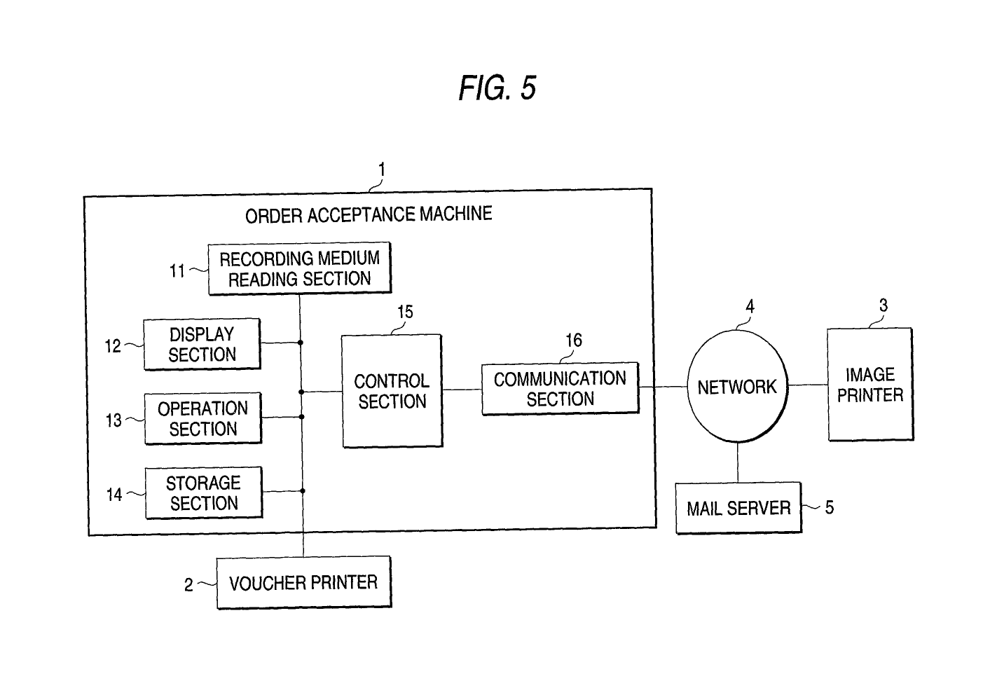

FIG. 5 shows the schematic configuration of an order acceptance system according to a second embodiment of the present invention. The order acceptance system shown in FIG. 5 is essentially identical with that shown in FIG. 1. Thumbnail images pertaining to the ordered images are sent to the customer rather than the thumbnail images being printed on a voucher. Consequently, the voucher printer 2 shown in FIG. 5 may print mere character information. Hence, a much simpler printer may serve sufficiently as the voucher printer 2.

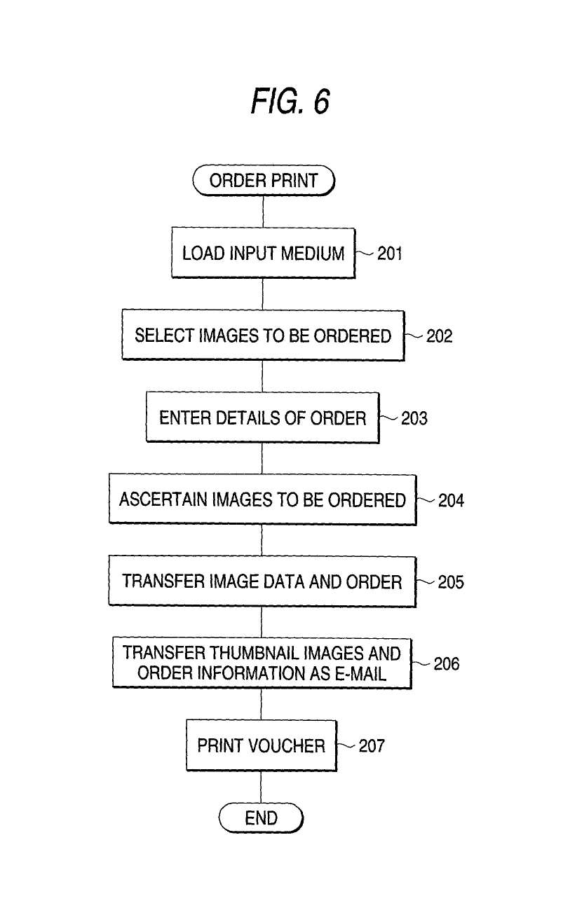

FIG. 6 shows flow of operations required when an order for prints is placed by utilization of the order acceptance system shown in FIG. 5. Processing pertaining to steps 201 through 205 shown in FIG. 6 is identical with that pertaining to steps 101 through 105 shown in FIG. 2, and hence repeated explanation thereof is omitted. In step 206, thumbnail images and order information are transmitted, in the form of an electronic mail, to a mail server 5 (one server is shown in FIG. 5 for the sake of convenience) disposed at the customer. The customer enters an electronic mail address at an appropriate point in time when placing an order. In step 207, payment of charges (in the case of a prepayment system) and printing of a voucher to be used for receiving ordered photo-prints are performed by means of the voucher printer 2. The sequence in which processing pertaining to steps 205, 206, and 207 is to be performed can be set arbitrarily in the same manner as in the case shown in FIG. 2.

What is claimed is:

1. A print order acceptance system for accepting an order for printing images on the basis of digital image data, wherein the system comprises:
an order acceptance machine which accepts digital image data and order information and transfers the image data and the order information to an image printer; and
a voucher printer which prints a voucher including thumbnail images and details of an order on the basis of the order information, the thumbnail images corresponding to image data which have been accepted by the order acceptance machine and have been transferred to the image printer.

2. The print order acceptance system according to claim 1, wherein the voucher printed by the voucher printer is used for ascertaining printouts of images at the time of receipt of printouts of images printed by the image printer on the basis of the image data that have been transferred to the image printer.

3. The print order acceptance system according to claim 1, wherein the order acceptance machine has means for displaying images on the basis of the accepted image data and transfers, to the image printer, image data pertaining to images selected from the displayed images.

4. The print order acceptance system according to any one of claims 1 through 3, wherein the order acceptance machine accepts thumbnail image data as well as the digital image data.

5. The print order acceptance system according to any one of claims 1 through 3, wherein the order acceptance machine produces thumbnail image data from the accepted digital image data.

6. A print order acceptance system for accepting an order for printing images on the basis of digital image data, wherein the system comprises:
an order acceptance machine which accepts digital image data and order information and transfers the image data and the order information to an image printer; and
electronic mail transmission means which transmits, to a person who has placed an order and in the form of an electronic mail, the order information and thumbnail images of the images which have been accepted by the order acceptance machine and transferred to the image printer.

7. The print order acceptance system according to claim 6, wherein the order acceptance machine has means for displaying images on the basis of the accepted image data and transfers, to the image printer, image data pertaining to images selected from the displayed images.

8. The print order acceptance system according to claim 6 or 7, wherein the order acceptance machine accepts thumbnail image data as well as the digital image data.

9. The print order acceptance system according to claim 6 or 7, wherein the order acceptance machine produces thumbnail image data from the accepted digital image data.

10. A print order acceptance method for accepting an order for printing images on the basis of digital image data, wherein the method comprises the steps of:
transferring to an image printer ordered image data and order information; and
instructing a voucher printer to print a voucher including thumbnail images and details of the order on the basis of the order information, the thumbnail images corresponding to image data which have been transferred to the image printer.

11. A print order acceptance method for accepting an order for printing images on the basis of digital image data, wherein the method comprises the steps of:
transferring to an image printer ordered image data and order information; and
transmitting, to a person who has placed the order and in the form of an electronic mail, thumbnail images corresponding to image data which have been transferred to the image printer and the order information.
